(19) United States
(12) Patent Application Publication
(10) Pub. No.: US 2006/0098038 A1
(43) Pub. Date: May 11, 2006

(54) Method and apparatus for compensating for energy difference of thermal print head

(75) Inventor: Dae-hyeok Im, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/250,417

(22) Filed: Oct. 17, 2005

(30) Foreign Application Priority Data
Nov. 5, 2004 (KR) 10-2004-0089697
Mar. 18, 2005 (KR) 10-2005-0022532

(51) Int. Cl. B41J 29/38

(52) U.S. Cl. 347/14

(57) ABSTRACT

Provided are a method and apparatus for compensating for an energy difference in a thermal print head that prints an image by heating a medium. The method includes measuring a direct current voltage of an adapter that applies a voltage to a heating unit when power is supplied to an image forming apparatus, and adjusting heating time of the heating unit using the measured direct current voltage. Accordingly, it is possible to obtain an even distribution of the optical density of an image without an additional voltage adjustment unit or manually compensating for the energy difference.

### BACKGROUND OF THE INVENTION

This application claims the benefit under 35 U.S.C. §119(a) of Korean Patent Application No. 10-2004-0089697, filed on Nov. 5, 2004 and Korean Patent Application No. 10-2005-0022532, filed on Mar. 18, 2005, in the Korean Intellectual Property Office, the entire disclosure of both of which are hereby incorporated by reference.

### FIELD OF THE INVENTION

The present invention relates to a method and apparatus for compensating for a difference of energy in a thermal print head. More particularly, the present invention relates to a method and apparatus for compensating for an energy difference in a thermal print head by adjusting the heating time of heating units of the thermal print head using the resistance of the heating units and the voltage applied to them.

### DESCRIPTION OF THE RELATED ART

In recent years, various types of thermal transfer printing apparatus have been developed for printing high-resolution images. A thermal transfer printing apparatus forms an image by transferring ink onto a medium by heating an ink ribbon that contacts a medium or heating an ink layer of a medium to reveal a predetermined color, using the thermal print head.

The thermal print head includes a plurality of heating units with a predetermined resistance R. When a predetermined voltage VHD is applied to the heating units, the heating units heat up and transfer heat onto the medium to print an image.

FIG. 1 is a graph showing data series 100 through 130 plotting the optical density (OD) of an image versus the voltage applied to the heating units of a thermal print head. If the heating units have a resistance R and the voltage applied to the heating units is VHD, the energy E applied to the heating units is computed by Equation (1). The OD of the image printed by heating the medium with the heating units is proportional to the energy E.

$$E = \frac{{VHD}^{2}}{R} \times t , \qquad ( 1 )$$

wherein t denotes the heating time during which the medium is heated by the heating units. The graphs 100 through 130 reveal that an increase in the voltage VHD results in an increase in the energy E applied to the heating units, thus increasing the OD of the image.

An error in the voltage applied to the heating units, or in their resistance, causes a difference in energy between the heating units, thereby preventing an even distribution of the optical density of the image. Accordingly, it is important to compensate for differences in applied voltage and resistence between the heating units to maintain an even distribution of optical density of the image.

FIG. 2 is a circuit diagram of a conventional apparatus for compensating for an energy difference in a thermal print head. The apparatus of FIG. 2 compensates for the difference of energy between heating units of the thermal print head by adjusting the voltage VHD applied to the heating units according to the resistance of the heating units. VHD is computed by substituting the resistance and heating time into Equation (1), and a variable resistor 220 of the apparatus is adjusted so that a voltage regulator 210 regulates a DC voltage applied from an adapter 200 down to the voltage VHD.

However, a DC/DC converter is needed to adjust the applied voltage to compensate for an energy difference in a thermal print head as described above, thus increasing the size, complexity and manufacturing costs of the image forming apparatus. Also, an additional process of adjusting the applied voltage by changing the variable resistance must be performed.

### SUMMARY OF THE INVENTION

The present invention provides a method and apparatus for adjusting an energy difference in a thermal print head, which prints an image while adjusting the heating time of the heating units of the thermal print head using the resistance of the heating units and the voltage applied to them.

According to an aspect of the present invention, there is provided a method of compensating for an energy difference in an image forming apparatus which uses a thermal print head which includes a heating unit, the method comprising measuring a voltage applied to the heating unit, and adjusting the heating time of the heating unit using the measured voltage.

The method further includes measuring the resistance of the heating unit.

The adjusting of the heating time comprises computing the heating time of the heating unit, using the resistance of the heating unit and the measured voltage.

The adjusting of the heating time comprises adjusting a width of a strobe signal which drives the heating unit, using the resistance of the heating unit and the measured voltage.

According to another aspect of the present invention, there is provided a method of compensating for an energy difference in an image forming apparatus which uses a thermal print head which includes a heating unit, the method comprising measuring a direct current voltage applied to the heating unit when power is supplied to the image forming apparatus, and adjusting heating time of the heating unit using the measured direct current voltage.

The adjusting of the heating time comprises computing the heating time using a resistance of the heating unit and the measured direct current voltage.

The adjusting of the heating time comprises adjusting a width of a strobe signal which drives the heating unit.

According to yet another aspect of the present invention, there is provided an apparatus for compensating for an energy difference in an image forming apparatus which uses a thermal print head which includes a heating unit, the apparatus comprising a voltage measurement unit measuring a voltage applied to the heating unit, and an adjustment unit adjusting heating time of the heating unit using the measured voltage.

The apparatus further includes a resistance measuring unit for measuring a resistance of the heating unit.

The adjustment unit computes the heating time of the heating unit using the measured voltage and the resistance of the heating unit.

When the measured voltage is applied to the adjustment unit, the adjustment unit adjusts a width of a strobe signal which drives the heating unit, using the measured voltage and the resistance of the heating unit.

The apparatus further includes a memory for storing the adjusted width of the strobe signal.

According to still another aspect of the present invention, there is provided an apparatus for compensating for an energy difference in an image forming apparatus which uses a thermal print head which includes a heating unit. The apparatus comprises a voltage measuring unit for measuring a direct current voltage applied to the heating unit when power is supplied to the image forming apparatus, and an adjustment unit for adjusting a heating time of the heating unit using the measured direct current voltage.

The adjustment unit computes the heating time of the heating unit using the measured voltage and a resistance of the heating unit.

The adjustment unit adjusts a width of a strobe signal which drives the heating unit using the measured voltage.

According to still another aspect of the present invention, there is provided an image forming apparatus which prints an image using a thermal print head with a heating unit. The apparatus comprises a voltage measuring unit for measuring a voltage applied to the heating unit, an adjustment unit for adjusting a width of a strobe signal which drives the heating unit, using the measured voltage, and a printing unit for printing an image by heating a medium using the heating unit in response to the adjusted strobe signal.

The voltage measuring unit measures the voltage applied to the heating unit when power is supplied to the image forming apparatus.

The voltage measuring unit measures a direct current voltage applied to the heating unit.

According to still another aspect of the present invention, there is provided a computer readable recording medium having embodied thereon a program for executing the method of compensating for an energy difference in an image forming apparatus which uses a thermal print head as described above.

### BRIEF DESCRIPTION OF THE DRAWINGS

The above and other aspects and advantages of the present invention will become more apparent by describing in detail exemplary embodiments thereof with reference to the attached drawings in which:

FIG. 1 is a graph plotting optical density versus the voltage applied to heating units of a thermal print head;

FIG. 2 is a circuit diagram of a conventional apparatus for compensating for an energy difference in a thermal print head;

FIG. 3 is a block diagram of an apparatus for compensating for an energy difference in a thermal print head according to an embodiment of the present invention;

FIG. 4 is a circuit diagram of a voltage measuring unit of FIG. 3 according to an embodiment of the present invention;

FIG. 5 is a circuit diagram of a voltage measuring unit of FIG. 3 according to another embodiment of the present invention;

FIG. 6 is a circuit diagram of a thermal print head according to an embodiment of the present invention;

FIG. 7 is a timing diagram of signals for driving a thermal print head according to an embodiment of the present invention;

FIG. 8 is a graph plotting the optical density of an image versus the voltage applied to a thermal print head in which an energy difference is compensated for according to an embodiment of the present invention; and

FIG. 9 is a flowchart illustrating a method of compensating for an energy difference in a thermal print head according to an embodiment of the present invention.

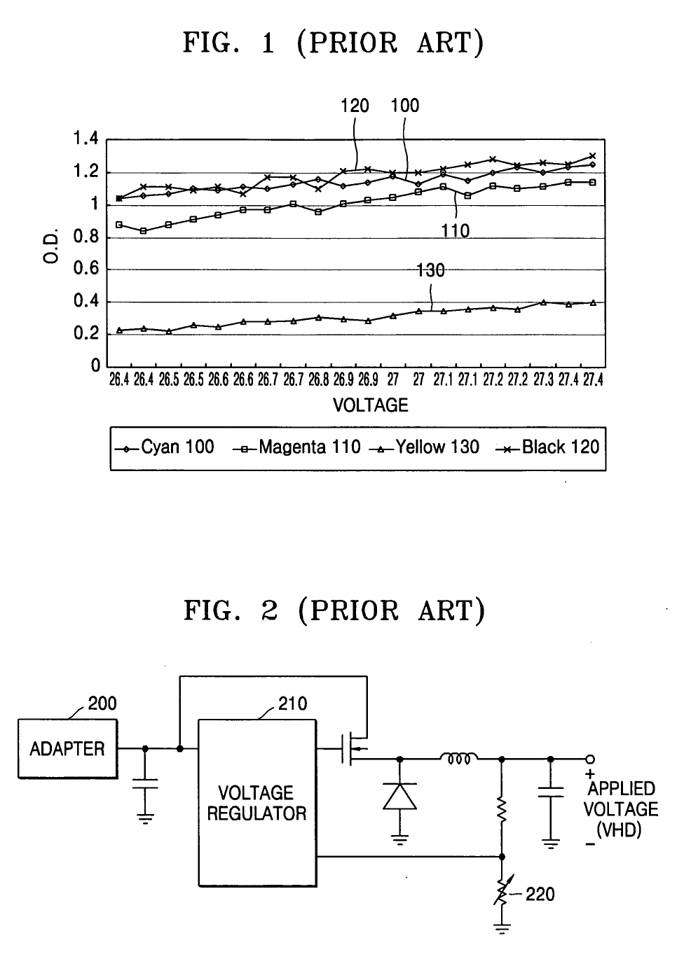

Throughout the drawings, like reference numbers will be understood to refer to like elements, features and structures.

### DETAILED DESCRIPTION OF EXEMPLARY EMBODIMENTS

Hereinafter, exemplary embodiments of the present invention will be described in detail with reference to the accompanying drawings.

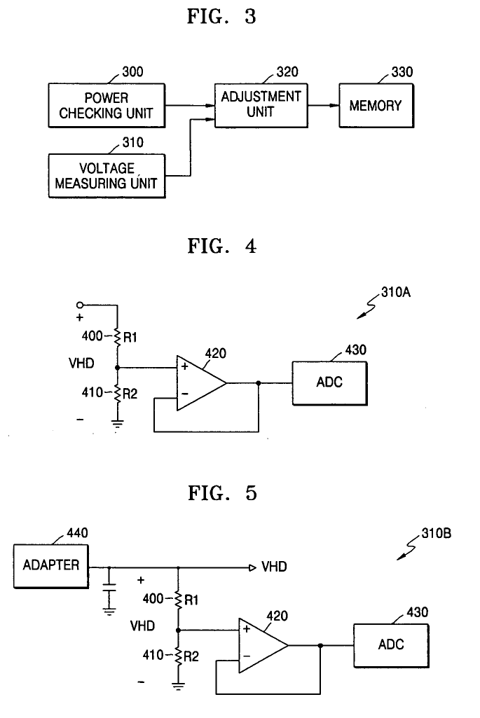

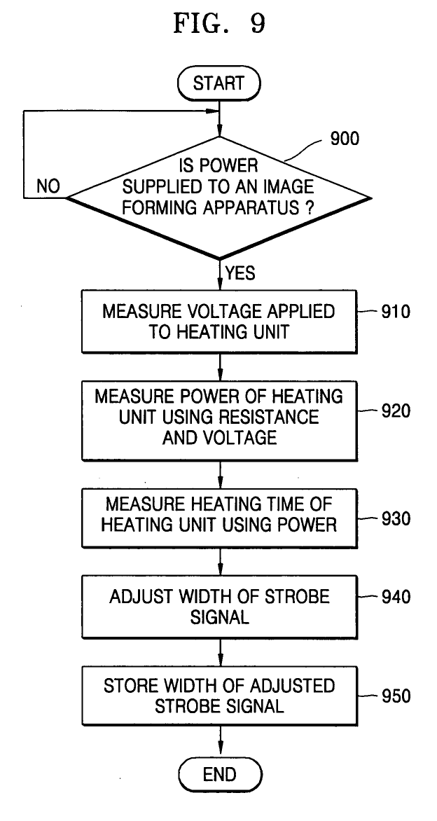

FIG. 3 is a block diagram of an apparatus for compensating for an energy difference in a thermal print head (not shown) according to an embodiment of the present invention. Referring to FIG. 3, the apparatus includes a power checking unit 300, a voltage measuring unit 310, an adjustment unit 320, and a memory 330. The operation of the apparatus of FIG. 3 will now be described with reference to a flowchart, shown in FIG. 9, which illustrates a method of compensating for an energy difference in a thermal print head according to an embodiment of the invention.

The power checking unit 300 determines whether power P is supplied to an image forming apparatus, that is, whether the image forming apparatus is turned on, and generates and outputs a signal that instructs the voltage measuring unit 310 to measure a resistance of a heating unit (not shown) when the image forming apparatus is turned on (operation 900).

In response to the signal received from the power checking unit 300, the voltage measuring unit 310 measures the voltage VHD applied to the heating unit (operation 910). FIG. 4 is a detailed block diagram of a voltage measuring unit 310A according to an embodiment of the present invention. Referring to FIG. 4, the voltage measuring unit 310A includes resistors R₁ 400 and R₂ 410, an OP amplifier 420, and an analog-to-digital converter (ADC) 430. The voltage VHD is divided by the resistors R₁ 400 and R₂ 410, passed through the OP amplifier 420, which is a buffer, and measured using the ADC 430. The ADC 430 can be any suitable ADC, such as a general ADC typically included in an image forming apparatus.

FIG. 5 is a detailed block diagram of a voltage measuring unit 310B according to another embodiment of the present invention. Referring to FIG. 5, the voltage measuring unit 310B, which includes resistors R₁ 400 and R₂ 410, an OP amplifier 420, and an ADC 430, preferably measure a DC voltage of an adapter 440 that applies a voltage VHD to heating units (not shown) so as to determine the voltage VHD.

When the voltage VHD measured by the voltage measuring unit 310 is applied to the adjustment unit 320, the adjustment unit 320 computes the power P supplied to the heating unit, by substituting the voltage VHD and a resistance R of the heating unit into Equation (2) (operation 920).

$$P = \frac{{VHD}^{2}}{R} \qquad ( 2 )$$

The resistance R of the heating unit has been determined and stored in the adjustment unit 320 during manufacture of the heating unit, or is input by a user when compensating for an energy difference in the thermal print head. Alternatively, the apparatus of FIG. 3 may further include a resistance measuring unit (not shown) that measures the resistance R of the heating unit.

The adjustment unit 320 computes heating time t during which a medium (not shown) is heated by the heating unit, by substituting the power P into Equation (3) (operation 930).

$$t = \frac{{E}_{s}}{P} , \qquad ( 3 )$$

wherein Eₛ denotes a reference value of energy to be applied to the heating unit to cancel the energy difference in the thermal print head. That is, the reference value Eₛ is a value of energy to be supplied to a medium for an even distribution of the optical density of an image.

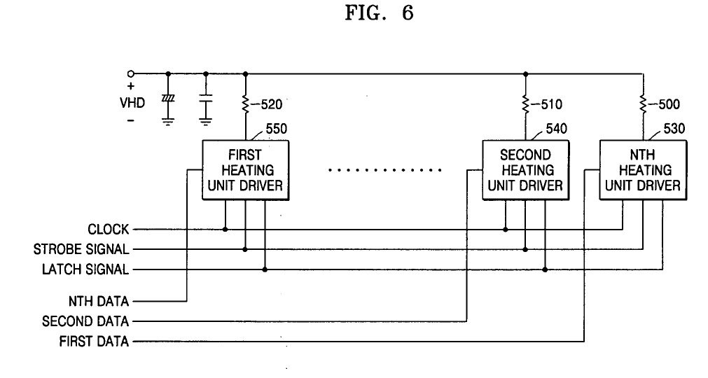

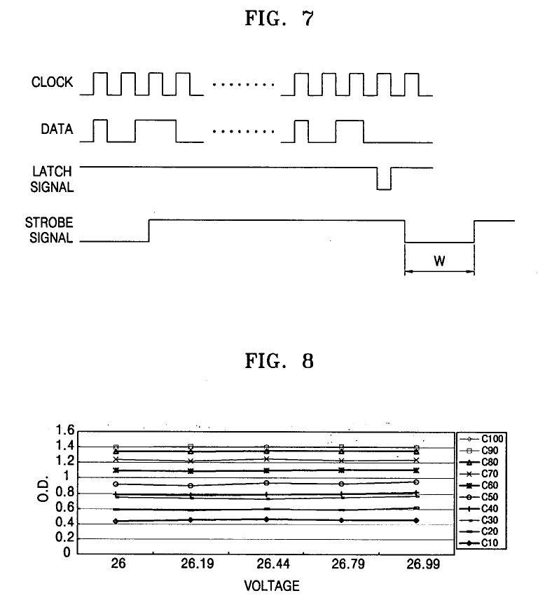

The adjustment unit 320 adjusts the width of a strobe signal for driving the heating units according to the heating time t (operation 940), and stores the width of the adjusted strobe signal in the memory 330 (operation 950). A method of adjusting the width of the strobe signal according to the heating time t will be described in detail with reference to FIGS. 6 and 7.

FIG. 6 is a circuit diagram of a thermal print head that includes a plurality of heating units 500, 510, and 520 and heating unit drivers 530, 540, and 550. The heating units 500 through 520 heat a medium (not shown) and are respectively driven by the heating unit drivers 530 through 550. A 300 dpi thermal print head 3 inches long includes 900 heating units. The heating units are switched on and off by their corresponding heating unit drivers and transfer heat generated by the voltage VHD to the medium.

When the thermal print head receives cyan (C), magenta (M), and yellow (Y) data and prints an image, the heating units must apply heat onto the medium a number of times ranging from 0 to 255 to print each of the C, M, and Y data, since the values of the C, M, and Y data range from 0 to 255. Therefore, the thermal print head requires 256 gradations to represent each of the C, M, and Y data.

FIG. 7 is a timing diagram of signals for driving a thermal print head, input for a gradation. Referring to FIG. 6, data indicating whether heating units of the thermal print head are heated, that is, whether they switched on or off, is input in series to shift registers of the heating unit drivers 530 through 550 of FIG. 5 in synchronization with a clock signal. After all the data is input to the shift registers, the data is temporarily stored in flip-flops of the heating unit drivers 530 through 550 corresponding to the heating units 500 through 520, in synchronization with a latch signal. When the data stored in the flip-flops is at a logic high level, the heating units 500 through 520 heat a medium (not shown) for the length of a time that corresponds to the width W of the strobe signal that is at a logic low level.

In other words, the width W of the strobe signal corresponds to the heating time during which the heating units heat the medium. Accordingly, it is possible to adjust the energy difference in the thermal print head by adjusting the heating time using the width W of the strobe signal.

FIG. 8 is a graph illustrating the optical density of an image versus the voltage applied to a thermal print head in which an energy difference is compensated for using a method according to the present invention, shown in Table 1.

TABLE 1

| color density | voltage (V) | | | | |
|---|---|---|---|---|---|
| (%) | 26 | 26.19 | 26.44 | 26.79 | 26.99 |
| 100 | 1.4 | 1.4 | 1.41 | 1.41 | 1.41 |
| 90 | 1.4 | 1.41 | 1.4 | 1.41 | 1.4 |
| 80 | 1.34 | 1.34 | 1.35 | 1.35 | 1.35 |
| 70 | 1.24 | 1.22 | 1.25 | 1.23 | 1.24 |
| 60 | 0.92 | 1.09 | 1.1 | 1.11 | 1.11 |
| 50 | 0.92 | 0.9 | 0.94 | 0.93 | 0.96 |
| 40 | 0.79 | 0.78 | 0.79 | 0.8 | 0.81 |
| 30 | 0.75 | 0.74 | 0.73 | 0.75 | 0.77 |
| 20 | 0.59 | 0.58 | 0.6 | 0.59 | 0.62 |
| 10 | 0.44 | 0.45 | 0.46 | 0.45 | 0.45 |
| Width of strobe | 330 | 330 | 330 | 330 | 330 |
| signal | | | | | |
| Width adjustment | +16 | +11 | +4 | −5 | −9 |
| value | | | | | |
| Width of adjusted | 346 | 341 | 334 | 325 | 321 |
| strobe signal | | | | | |

Table 1 shows the widths of the strobe signal adjusted according to the heating time of the heating units of the thermal print head, which is computed while increasing the voltage applied to the heating units from 26V to 26.99V.

The graph of FIG. 8 reveals that it is possible to obtain even distribution of the optical density of an image irrespective of variations in the voltage applied to the heating units, by compensating for an energy difference in the thermal print head by adjusting the width of the strobe signal, using the method according to an embodiment of the present invention.

As described above, in a method and apparatus for compensating for an energy difference in a thermal print head according to embodiments of the present invention, when an image is printed using a thermal print head, the image is printed while adjusting the heating time of heating units of the thermal print head using the resistance of the heating units and the voltage applied to them. Accordingly, it is possible to obtain an even distribution of the optical density of an image without an additional voltage adjustment unit or manually compensating for the energy difference.

Embodiments of the present invention can be embodied as computer readable code in a computer readable medium. The computer readable medium may be any recording apparatus capable of storing data that is read by a computer system, such as, a read-only memory (ROM), a random access memory (RAM), a compact disc (CD)-ROM, a magnetic tape, a floppy disk, an optical data storage device, and the like. Also, the computer readable medium may be a carrier wave that transmits data via the Internet, for example. The computer readable recording medium can be distributed among computer systems that are interconnected through a network, and embodiments of the present invention may be stored and implemented as computer readable code in the distributed system. A functional program, code, and code segments required to perform the present invention can be easily derived by programmers in the art.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A method of compensating for an energy difference in an image forming apparatus which uses a thermal print head which includes a heating unit, the method comprising:
measuring a voltage applied to the heating unit; and
adjusting a heating time of the heating unit using the measured voltage.

2. The method of claim 1, further comprising measuring the resistance of the heating unit.

3. The method of claim 1, wherein the adjusting of the heating time comprises computing the heating time of the heating unit, using the resistance of the heating unit and the measured voltage.

4. The method of claim 1, wherein the adjusting of the heating time comprises adjusting a width of a strobe signal which drives the heating unit, using the resistance of the heating unit and the measured voltage.

5. A method of compensating for an energy difference in an image forming apparatus which uses a thermal print head which includes a heating unit, the method comprising:
measuring a direct current voltage applied to the heating unit when power is supplied to the image forming apparatus; and
adjusting heating time of the heating unit using the measured direct current voltage.

6. The method of claim 5, wherein the adjusting of the heating time comprises computing the heating time using a resistance of the heating unit and the measured direct current voltage.

7. The method of claim 5, wherein the adjusting of the heating time comprises adjusting a width of a strobe signal which drives the heating unit.

8. An apparatus for compensating for an energy difference in an image forming apparatus which uses a thermal print head which includes a heating unit, the apparatus comprising:
a voltage measurement unit for measuring a voltage applied to the heating unit; and
an adjustment unit for adjusting a heating time of the heating unit using the measured voltage.

9. The apparatus of claim 8, further comprising a resistance measuring unit for measuring a resistance of the heating unit.

10. The apparatus of claim 8, wherein the adjustment unit computes the heating time of the heating unit using the measured voltage and the resistance of the heating unit.

11. The apparatus of claim 8, wherein when the measured voltage is applied to the adjustment unit, the adjustment unit adjusts a width of a strobe signal which drives the heating unit, using the measured voltage and the resistance of the heating unit.

12. The apparatus of claim 8, further comprising a memory for storing the adjusted width of the strobe signal.

13. An apparatus for compensating for an energy difference in an image forming apparatus which uses a thermal print head which includes a heating unit, the apparatus comprising:
a voltage measuring unit for measuring a direct current voltage applied to the heating unit when power is supplied to the image forming apparatus; and
an adjustment unit for adjusting a heating time of the heating unit using the measured direct current voltage.

14. The apparatus of claim 13, wherein the adjustment unit computes the heating time of the heating unit using the measured voltage and a resistance of the heating unit.

15. The apparatus of claim 13, wherein the adjustment unit adjusts a width of a strobe signal which drives the heating unit using the measured voltage.

16. An image forming apparatus which prints an image using a thermal print head with a heating unit, the apparatus comprising:
a voltage measuring unit for measuring a voltage applied to the heating unit;
an adjustment unit for adjusting a width of a strobe signal which drives the heating unit, using the measured voltage; and
a printing unit for printing an image by heating a medium using the heating unit in response to the adjusted strobe signal.

17. The image forming apparatus of claim 16, wherein the voltage measuring unit measures the voltage applied to the heating unit when power is supplied to the image forming apparatus.

18. The image forming apparatus of claim 16, wherein the voltage measuring unit measures a direct current voltage applied to the heating unit.

19. A computer readable recording medium having embodied thereon a program for executing the method of claim 1 in a computer.

20. A computer readable recording medium having embodied thereon a program for executing the method of claim 5 in a computer.
